(19) United States
(12) Patent Application Publication
(10) Pub. No.: US 2019/0105884 A1
(43) Pub. Date: Apr. 11, 2019

(54) COATED FILMS AND PACKAGES FORMED FROM SAME

(71) Applicant: Dow Global Technologies LLC, Midland, MI (US)

(72) Inventors: Anne M. Kelly-Rowley, Midland, MI (US); Mechelle Ann Churchfield, Midland, MI (US); Nicole L. Wagner, Midland, MI (US); Paul J. Popa, Auburn, MI (US); Larry Jopko, Lake Jackson, TX (US); Cristina Serrat, Sugar Land, TX (US)

(21) Appl. No.: 16/094,627

(22) PCT Filed: May 25, 2017
(86) PCT No.: PCT/US2017/034525

§ 371 Date: Oct. 18, 2018

Related U.S. Application Data
(60) Provisional application No. 62/343,428, filed on May 31, 2016.

(51) Int. Cl. B32B 27/32; C08J 7/04

(52) U.S. Cl. CPC B32B 27/327; C08J 2323/08; C08J 2475/04; C08J 7/047

(57) ABSTRACT

The present invention provides coated films and packages formed from such films. In one aspect, a coated film comprises (a) a film comprising (i) a first layer comprising from 70 to 100 percent by weight of a polyethylene having a density 0.930 g/cm³ or less and a peak melting point of less than 126° C.; (ii) a second layer comprising from 60 to 100 percent by weight polyethylene having a density of 0.905 to 0.970 g/cm³ and a peak melting point in the range of 100° C. to 135° C.; and (iii) at least one inner layer between the first layer and the second layer comprising from 40 to 100 percent by weight of a polyethylene having a density from 0.930 to 0.970 g/cm³ and a peak melting point in the range of 120° C. to 135° C., wherein the polyethylene is a medium density polyethylene or a high density polyethylene; and (b) a coating on an outer surface of the second layer of the film comprising a crosslinked polyurethane, wherein the coating is substantially free of isocyanate groups. In some embodiments, the coated film is thermally resistant when subjected to a W-fold test at a temperature of at least 230° F., and/or has a gloss of at least 70 units at 60°.

### FIELD

The present invention relates to coated films that can be used in packages. Such coated films can be particularly useful in food packages such as stand-up pouches.

### INTRODUCTION

For years, many types of flexible and semi-rigid packaging created to protect food, liquids, personal care items, and other consumer products have been manufactured with a structure that typically combines polyester and/or polypropylene layer(s) with polyethylene films using a reactive polyurethane adhesive to make a laminate of the various layers. Such film structures combine the gloss, stiffness, thermal resistance, and oxygen barrier properties of polyester and/or polypropylene layers with the water vapor barrier, mechanical, and sealing properties of polyethylene layers. In addition, some packages include metal foil layers, paperboard layers, and other layers. Of course, the barrier properties (resistance (or lack of resistance) to oxygen and water vapor transmission) can be selected based on the type of product to be packaged.

While such packages combine a number of properties, one of the primary challenges of such packages is the many conversion and fabrication steps that can be required to manufacture the package. Another challenge with such packages is the disposal of such packages. With such packages being made up of mixed plastics and/or metal foils and/or paperboard, the packages are usually discarded as waste due to the incompatibility of these materials.

It would thus be desirable to have films for use in packages that are substantially made from a single material (e.g., polyethylene), that is, made with one or more layers formed from the same material (e.g., polyethylene), while minimizing the presence of other materials except as needed to provide a functionality that the primary material used is not able to provide.

### SUMMARY

The present invention provides coated films that advantageously combine polyethylene-based films (including monolayer and multi-layer films, with and without lamination to polyethylene films) with a polyurethane coating that advantageously provide desirable properties to packages for an improved compatibility/recyclability profile. In some embodiments, the present invention provides coated films for packages that have sealing temperature ranges and gloss that are comparable to polyester or polypropylene-based films but that can be produced in simplified manufacturing processes. For example, in some embodiments, the polyurethane coating can be applied to an outer surface of a polyethylene-based film in-line (e.g., following extrusion) to provide the coated films. In some embodiments, the polyurethane coating is substantially free of isocyanate groups. In some embodiments, the present invention advantageously simplifies film production processes for packaging and minimizes the use of incompatible materials that cause difficulties in recycling.

In one aspect, the present invention provides a coated film that comprises (a) a film comprising (i) a first layer comprising from 70 to 100 percent by weight of a polyethylene having a density of 0.930 g/cm³ or less and a peak melting point of less than 126° C.; (ii) a second layer comprising from 60 to 100 percent by weight polyethylene having a density of 0.905 to 0.970 g/cm³ and a peak melting point in the range of 100° C. to 135° C.; and (iii) at least one inner layer between the first layer and the second layer comprising from 40 to 100 percent by weight of a polyethylene having a density from 0.930 to 0.970 g/cm³ and a peak melting point in the range of 120° C. to 135° C., wherein the polyethylene is a medium density polyethylene or a high density polyethylene; and (b) a coating on an outer surface of the second layer of the film comprising a crosslinked polyurethane, wherein the coating is substantially free of isocyanate groups. In some embodiments, the coated film is thermally resistant when subjected to a W-fold test at a temperature of at least 230° F., and/or has a gloss of at least 70 units at 60°. In some embodiments, the first layer is a sealing layer.

In another aspect, the present invention provides a coated film that comprises (a) a monolayer film comprising from 70 to 100 percent by weight polyethylene having a density of 0.930 g/cm³ or less and a melt index (I₂) of less than 2.0 g/10 minutes, and a peak melting point of less than 126° C.; and (b) a coating on an outer surface of the film comprising crosslinked polyurethane, wherein the coating is substantially free of isocyanate groups. In some embodiments, the coated film is thermally resistant when subjected to a W-fold test at a temperature of at least 230° F., and/or has a gloss of at least 70 units at 60°. Such temperature ranges can facilitate the use of such coated films in form fill and seal packaging processes with minimal detriment on productivity.

Embodiments of the present invention also provide articles (e.g., pillow pouches, stand-up pouches, etc.) formed from the coated films disclosed herein.

These and other embodiments are described in more detail in the Detailed Description.

### DETAILED DESCRIPTION

Unless specified otherwise herein, percentages are weight percentages (wt %) and temperatures are in ° C.

The term “composition,” as used herein, includes material(s) which comprise the composition, as well as reaction products and decomposition products formed from the materials of the composition.

The term “comprising,” and derivatives thereof, is not intended to exclude the presence of any additional component, step or procedure, whether or not the same is disclosed herein. In order to avoid any doubt, all compositions claimed herein through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

The term “polymer,” as used herein, refers to a polymeric compound prepared by polymerizing monomers, whether of the same or a different type. The generic term polymer thus embraces the term homopolymer (employed to refer to polymers prepared from only one type of monomer, with the understanding that trace amounts of impurities can be incorporated into the polymer structure), and the term interpolymer as defined hereinafter. Trace amounts of impurities may be incorporated into and/or within the polymer.

The term “interpolymer,” as used herein, refers to a polymer prepared by the polymerization of at least two different types of monomers. The generic term interpolymer thus includes copolymers (employed to refer to polymers prepared from two different types of monomers), and polymers prepared from more than two different types of monomers. The term “polymer”, as used herein, refers to a polymeric compound prepared by polymerizing monomers, whether of the same or a different type. The generic term polymer thus embraces the term “homopolymer”, usually employed to refer to polymers prepared from only one type of monomer as well as “copolymer” which refers to polymers prepared from two or more different monomers.

“Polyethylene” shall mean polymers comprising greater than 50% by weight of units which have been derived from ethylene monomer. This includes polyethylene homopolymers or copolymers (meaning units derived from two or more comonomers). Common forms of polyethylene known in the art include Low Density Polyethylene (LDPE); Linear Low Density Polyethylene (LLDPE); Ultra Low Density Polyethylene (ULDPE); Very Low Density Polyethylene (VLDPE); single site catalyzed Linear Low Density Polyethylene, including both linear and substantially linear low density resins (m-LLDPE); Medium Density Polyethylene (MDPE); and High Density Polyethylene (HDPE). These polyethylene materials are generally known in the art; however the following descriptions may be helpful in understanding the differences between some of these different polyethylene resins.

The term “LDPE” may also be referred to as “high pressure ethylene polymer” or “highly branched polyethylene” and is defined to mean that the polymer is partly or entirely homopolymerized or copolymerized in autoclave or tubular reactors at pressures above 14,500 psi (100 MPa) with the use of free-radical initiators, such as peroxides (see for example U.S. Pat. No. 4,599,392, which is hereby incorporated by reference). LDPE resins typically have a density in the range of 0.916 to 0.940 g/cm³.

The term “LLDPE”, includes resins made using the traditional Ziegler-Natta catalyst systems as well as single-site catalysts such as bis-metallocenes (sometimes referred to as “m-LLDPE”), post-metallocene catalysts, and constrained geometry catalysts, and includes linear, substantially linear or heterogeneous polyethylene copolymers or homopolymers. LLDPEs contain less long chain branching than LDPEs and includes the substantially linear ethylene polymers which are further defined in U.S. Pat. Nos. 5,272,236, 5,278,272, 5,582,923 and 5,733,155; the homogeneously branched linear ethylene polymer compositions such as those in U.S. Pat. No. 3,645,992; the heterogeneously branched ethylene polymers such as those prepared according to the process disclosed in U.S. Pat. No. 4,076,698; and/or blends thereof (such as those disclosed in U.S. Pat. Nos. 3,914,342 or 5,854,045). The LLDPEs can be made via gas-phase, solution-phase or slurry polymerization or any combination thereof, using any type of reactor or reactor configuration known in the art, with gas and slurry phase reactors being most preferred.

The term “MDPE” refers to polyethylenes having densities from 0.926 to 0.940 g/cm³. “MDPE” is typically made using chromium or Ziegler-Natta catalysts or using metallocene, constrained geometry, or single site catalysts, and typically have a molecular weight distribution (“MWD”) greater than 2.5.

The term “HDPE” refers to polyethylenes having densities greater than about 0.940 g/cm³, which are generally prepared with Ziegler-Natta catalysts, chrome catalysts, post-metallocene catalysts, or constrained geometry catalysts.

“Multimodal” means resin compositions which can be characterized by having at least two distinct peaks in a GPC chromatogram showing the molecular weight distribution. Multimodal includes resins having two peaks as well as resins having more than two peaks.

As used herein, the term “polyaldehyde” means a molecule containing two or more aldehyde groups or their hydrates, or their acetals or hemiacetals, wherein the molecule is capable of performing as described herein and is capable of reacting with the polycarbamate during the invention curing step so as to form the invention crosslinked polyurethane. The aldehyde group can be written herein as —C(═O)H or —CHO. The term “polyaldehyde” is not used herein to mean a polymeric substance made by self-polymerizing an aldehyde monomer.

Unless otherwise noted herein, the term “carbamate group” means a radical structure of formula

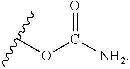 [SMILES: *OC(N)=O]

As used herein, the term “polycarbamate” means a molecule containing two or more carbamate groups (H₂NC(O)O—), wherein the molecule is capable of reacting with the polyaldehyde during the invention curing step so as to form the invention crosslinked polyurethane.

As used herein, the term “substantially free of isocyanate groups” or “substantially isocyanate-free” groups means having less than 5 mole percent (mol %) of —N═C═O groups (i.e., isocyanate groups) based on total moles of carbamate groups plus isocyanate groups in the composition, preferably, less than 3 mol %, or, more preferably, less than 1 mol %, and, still more preferably, less than 0.1 mol %.

As used herein, the term “crosslinked polyurethane” means a polymeric substance comprising two adjacent molecular backbones, each of which independently contains a plurality of repeat units, each repeat unit independently comprising a connecting carbamate diradical, or any two adjacent repeat units together comprising a connecting carbamate diradical, or a combination thereof; wherein the adjacent molecular backbones are covalently bonded together via at least one covalent bond of the connecting carbamate diradical, thereby covalently bonding the adjacent molecular backbones together so as to form a single crosslinked polyurethane molecule. The connecting carbamate diradical is described later.

As used herein, the term “carbamate diradical” means a “

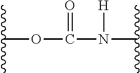 [SMILES: *NC(=O)O*]

” group.

As used herein, “

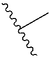

” (or an end “−” taken in context) indicates a radical. Each of the covalently bonded adjacent molecular backbones independently is linear or branched and independently contains zero, one, or more cyclic groups, including aromatic groups. Each molecular backbone can be covalently bonded to one or more other molecular backbones.

As used herein, the term “curing” means subjecting to conditions effective for chemically transforming or chemically transforming under such conditions.

As used herein, the term “curing temperature” means a degree of hotness or coldness effective for chemically transforming the invention ambient temperature curable composition to the invention crosslinked polyurethane. As used herein, the term “crosslinked polyurethane” means a polymeric substance comprising two adjacent molecular backbones, each of which independently contains a plurality of repeat units, each repeat unit independently comprising a connecting carbamate diradical, or any two adjacent repeat units together comprising a connecting carbamate diradical, or a combination thereof;

wherein the adjacent molecular backbones are covalently bonded together via at least one covalent bond of the connecting carbamate diradical, thereby covalently bonding the adjacent molecular backbones together so as to form a single crosslinked polyurethane molecule. The connecting carbamate diradical is described later.

As used herein, the term “carbamate diradical” means a “ ” group.

As used herein, “ ” (or an end “-” taken in context) indicates a radical. Each of the covalently bonded adjacent molecular backbones independently is linear or branched and independently contains zero, one, or more cyclic groups, including aromatic groups. Each molecular backbone can be covalently bonded to one or more other molecular backbones.

As used herein, the term “curing” means subjecting to conditions effective for chemically transforming or chemically transforming under such conditions.

As used herein, the term “curing temperature” means a degree of hotness or coldness effective for chemically transforming the invention ambient temperature curable composition to the invention crosslinked polyurethane.

Unless otherwise indicated herein, the following analytical methods are used in the describing aspects of the present invention:

Melt index: Melt indices I₂ (or I2) and I₁₀ (or I10) are measured in accordance to ASTM D-1238 at 190° C. and at 2.16 kg and 10 kg load, respectively. Their values are reported in g/10 min.

Density: Samples for density measurement are prepared according to ASTM D4703. Measurements are made, according to ASTM D792, Method B, within one hour of sample pressing.

Peak melting point is determined by Differential Scanning calorimeter (DSC) where the film is conditioned at 230° C. for 3 minutes prior to cooling at a rate of 10° C. per minute to a temperature of 40° C. After the film is kept at −40° C. for 3 minutes, the film is heated to 200° C. at a rate of 10° C. per minute.

The term molecular weight distribution or “MWD” is defined as the ratio of weight average molecular weight to number average molecular weight (M_{w}/Mₙ). M_{w} and Mₙ are determined according to methods known in the art using conventional gel permeation chromatography (conventional GPC).

Gloss is determined according to ASTM D2457.

Coefficient of Friction is determined according to ASTM 1894.

Additional properties and test methods are described further herein.

In one aspect, the present invention provides a coated film that comprises (a) a film comprising (i) a first layer comprising from 70 to 100 percent by weight of a polyethylene having a density of 0.930 g/cm³ or less and a peak melting point of less than 126° C.; (ii) a second layer comprising from 60 to 100 percent by weight polyethylene having a density of 0.905 to 0.970 g/cm³ and a peak melting point in the range of 100° C. to 135° C.; and (iii) at least one inner layer between the first layer and the second layer comprising from 40 to 100 percent by weight of a polyethylene having a density from 0.930 to 0.970 g/cm³ and a peak melting point in the range of 120° C. to 135° C., wherein the polyethylene is a medium density polyethylene or a high density polyethylene; and (b) a coating on an outer surface of the second layer of the film comprising a crosslinked polyurethane, wherein the coating is substantially free of isocyanate groups.

In another aspect, the present invention provides a coated film that comprises (a) a film comprising (i) a first layer comprising from 70 to 100 percent by weight of a polyethylene having a density of 0.930 g/cm³ or less and a peak melting point of less than 126° C.; (ii) a second layer comprising from 60 to 100 percent by weight polyethylene having a density of 0.905 to 0.970 g/cm³ and a peak melting point in the range of 100° C. to 135° C.; and (iii) at least one inner layer between the first layer and the second layer comprising from 40 to 100 percent by weight of a polyethylene having a density from 0.930 to 0.970 g/cm³ and a peak melting point in the range of 120° C. to 135° C., wherein the polyethylene is a medium density polyethylene or a high density polyethylene; and (b) a coating on an outer surface of the second layer of the film comprising a crosslinked polyurethane, wherein the coating is substantially free of isocyanate groups, wherein the coated film is thermally resistant when subjected to a W-fold test at a temperature of at least 230° F., and/or has a gloss of at least 70 units at 60°.

In another aspect, the present invention provides a coated film that comprises (a) a monolayer film comprising from 70 to 100 percent by weight polyethylene having a density of 0.930 g/cm³ or less and a melt index (I₂) of less than 2.0 g/10 minutes, and a peak melting point of less than 126° C.; and (b) a coating on an outer surface of the film comprising a crosslinked polyurethane, wherein the coating is substantially free of isocyanate groups. In another aspect, the present invention provides a coated film that comprises (a) a monolayer film comprising from 70 to 100 percent by weight polyethylene having a density of 0.930 g/cm³ or less and a melt index (I₂) of less than 2.0 g/10 minutes, and a peak melting point of less than 126° C.; and (b) a coating on an outer surface of the film comprising a crosslinked polyurethane, wherein the coating is substantially free of isocyanate groups, wherein the coated film is thermally resistant when subjected to a W-fold test at a temperature of at least 230° F., and/or has a gloss of at least 70 units at 60°.

In some embodiments, the polyurethane is formed from: (a) a polycarbamate having an average of 2.5 or more carbamate functional groups; and (b) a polyaldehyde, wherein the polyaldehyde is a dialdehyde, a trialdehyde, or an acetal or hemiacetal thereof, and wherein the polyaldehyde comprises 2 to 20 carbon atoms. Additional details regarding the polyurethane that can be used in the coating in various embodiments of the present invention are provided herein. In some embodiments, the coating further comprises at least one of oil and wax.

The coated film is a blown film in some embodiments. In embodiments where the coated film is a multilayer blown film, the polyethylene in the first layer, the polyethylene in the second layer, and the polyethylene in at least one additional layer each have a melt index (I₂) of less than 2.0 g/10 minutes.

In some embodiments, the coated film is a cast film. In embodiments where the coated film is a multilayer cast film, the polyethylene in the first layer, the polyethylene in the second layer, and the polyethylene in the at least one additional layer each have a melt index (I₂) of 2.0 g/10 minutes or more. In some embodiments, one or more of the polyethylene in the first layer, the polyethylene in the second layer, and the polyethylene in the at least one additional layer can have a melt index (I₂) of less than 2.0 g/10 minutes. In some embodiments, one or more of the polyethylene in the first layer, the polyethylene in the second layer, and the polyethylene in the at least one additional layer can have a melt index (I₂) of 0.1-2.0 g/10 minutes, or 0.5-2.0 g/10 minutes.

The coated film, in some embodiments, has a gloss of at least 85 units at 60°.

The amount of coating on the outer surface of the film (or the outer surface of a layer of a multilayer film), in some embodiments, is 1 to 7 g/m².

In some embodiments, the coated film has a kinetic coefficient of friction of 0.10 to 1.5 on the coated surface.

In some embodiments where the film is a multilayer layer film comprising two or more layers, the film can comprise one or more lower density inner layers between the first layer and the second layer comprising from 50 to 100 percent by weight polyethylene having a density of 0.92 g/cm³ or less, and a peak melting point in the range of 90° C. to 120° C., preferably 100° C. to 115° C. In some embodiments where the film is a multilayer layer film comprising two or more layers, the film can comprise one or more layers comprising polypropylene, propylene-based copolymers, a cyclic olefin copolymer, or mixtures thereof. In some embodiments where the film is a multilayer layer film comprising two or more layers, the film can further comprise a barrier layer. A barrier layer, in such embodiments, can comprise, for example, polyamide or ethylene vinyl alcohol.

Embodiments of the present invention also provide articles formed from any of the coated films described herein. In some such embodiments, the coated film has a thickness of 20 to 200 microns. Examples of such articles can include flexible packages, like pillow pouches and stand-up pouches. In some embodiments, coated films of the present invention can be used in form, fill and seal processes to make packages or other articles.

As noted above, in some embodiments, the film is a multilayer film. In such embodiments, a first layer comprises from 70 to 100 percent by weight of polyethylene having a density of 0.930 g/cm³ or less. The first layer is a surface layer in some embodiments. All individual values and subranges from 70 to 100 percent by weight (wt %) are included herein and disclosed herein; for example the amount of the linear low density polyethylene can be from a lower limit of 70, 80, or 90 wt % to an upper limit of 80, 90, or 100 wt %. For example, the amount of the first linear low density polyethylene can be from 80 to 100 wt %, or in the alternative, from 70 to 90 wt %, or in the alternative, from 75 to 95 wt %, or in the alternative from 80 to 100 wt %.

The polyethylene in the first layer has a density less than or equal to 0.930 g/cc (cm³). All individual values and subranges less than or equal to 0.930 g/cc are included herein and disclosed herein; for example, the density of the polyethylene can be from an upper limit of 0.928, 0.925, 0.920 or 0.915 g/cc In some aspects of the invention, the polyethylene in the first layer has a density greater than or equal to 0.870 g/cc. All individual values and subranges between 0.870 and 0.930 are included herein and disclosed herein.

The polyethylene having a density of 0.930 g/cm³ or less in the first layer has a peak melting point of 126° C. or less in some embodiments, preferably between 70 and 121° C., more preferably between 80 and 121° C.

The melt index of the polyethylene having a density of 0.930 g/cm³ or less in the first layer can depend on a number of factors including whether the film is a blown film or a cast film. In embodiments where the film is a blown film, the polyethylene in the first layer has an 12 less than or equal to 2.0 g/10 minutes. All individual values and subranges from −2.0 g/10 minutes are included herein and disclosed herein. For example, the polyethylene can have a melt index from an upper limit of 2.0, 1.7, 1.4, 1.1, or 0.9 g/10 minutes. In a particular aspect of the invention, the polyethylene has an 12 with a lower limit of 0.1 g/10 minutes. All individual values and subranges from 0. 1 g/10 minutes are included herein and disclosed herein. For example, the polyethylene in the first layer can have an I₂ greater than or equal to 0.1, 0.2, 0.3, or 0.4 g/10 minutes.

In other embodiments, the film can be a cast film. In such embodiments, the polyethylene having a density of 0.930 g/cm³ or less in the first layer has an I₂ greater than or equal to 2.0 g/10 minutes. All individual values and subranges above 2.0 g/10 minutes are included herein and disclosed herein. For example, the polyethylene can have a melt index from a lower limit of 2.0, 3.0, 4.0, 5.0, 6.0, or 10 g/10 minutes. In some embodiments, the polyethylene for a cast film application can have an upper melt index limit of 15 g/10 minutes. In some embodiments, depending on the other components in the first layer or other layers, the polyethylene in the first layer for a cast film application can have an upper limit of 12 of less than 2.0 g/10 minutes. In some embodiments, the polyethylene in the first layer for a cast film application can have a melt index (I₂) of 0.1-2.0 g/10 minutes, or 0.5-2.0 g/10 minutes. All individual values and subranges from 0.1 to 2.0 g/10 minutes are included herein and disclosed herein.

Examples of polyethylenes having a density of 0.930 g/cm³ or less that can be used in the first layer include linear low density polyethylenes, polyolefin plastomers, ultra low density polyethylenes, and enhanced polyethylenes. Such polyethylenes include those commercially available from The Dow Chemical Company under the names AFFINITY™, ELITE™ AT, and ATTANE™ including, for example, AFFINITY™ PL 1146G polyolefin plastomer, AFFINITY™ PL 1888 polyolefin plastomer, ELITE™ AT 6401 enhanced polyethylene, ELITE™ 5401G enhanced polyethylene, and ATTANE™ 4203 ultra low density polyethylene.

In embodiments where the first layer comprises <100% of the polyethylene having a density of 0.930 g/cm³ or less, the first layer further comprises one or more additional polyethylene resins such as, for example, one or more low density polyethylenes having a melt index from 0.1 to 5 g/10 minutes, one or more linear low density polyethylenes having a density of 0.930 g/cc or more and a melt index from 0.1 to 5 g/10 minutes.

In embodiments wherein the film comprises a multilayer film, a second layer comprises from 60 to 100 percent by weight of a polyethylene. The second layer is another surface layer in some embodiments. All individual values and subranges from 60 to 100 percent by weight (wt %) are included herein and disclosed herein; for example the amount of the polyethylene can be from a lower limit of 60, 70, 80, or 90 wt % to an upper limit of 70, 80, 90, or 100 wt %. For example, the amount of the polyethylene can be from 70 to 100 wt %, or in the alternative, from 60 to 90 wt %, or in the alternative, from 65 to 95 wt %, or in the alternative from 70 to 100 wt %.

The polyethylene in the second layer has a density of 0.905 to 0.970 g/cc (cm³). All individual values and subranges from 0.910 to 0.970 g/cc are included herein and disclosed herein; for example, the density of the polyethylene can be from a lower limit of 0.905, 0.910, 0.920, 0.930, 0.940, or 0.950 g/cc to an upper limit of 0.930, 0.940, 0.950, 0.960, 0.970 g/cc. In some embodiments, the polyethylene has a density from 0.910 to 0.970 g/cc, preferably between 0.920 to 0.960 g/cc, more preferably between 0.940 to 0.960 g/cc.

The polyethylene in the second layer has a peak melting point of 100° C. to 135° C. in some embodiments, preferably between 121 and 132° C., more preferably between 126 and 132° C.

The melt index of the polyethylene in the second layer can depend on a number of factors including whether the film is a blown film or a cast film. In embodiments where the film is a blown film, the polyethylene has an 12 less than or equal to 2.0 g/10 minutes. All individual values and subranges from 2.0 g/10 minutes are included herein and disclosed herein. For example, the polyethylene can have a density from an upper limit of 2.0, 1.7, 1.4, 1.1, or 0.9 g/10 minutes. In a particular aspect of the invention, the polyethylene has an I₂ with a lower limit of 0.1 g/10 minutes. All individual values and subranges from 0.1 g/10 minutes are included herein and disclosed herein. For example, the polyethylene can have an I₂ greater than or equal to 0.1, 0.2, 0.3, or 0.5 g/10 minutes.

In other embodiments, the film can be a cast film. In such embodiments, the polyethylene in the second layer has an I₂ greater than or equal to 2.0 g/10 minutes. All individual values and subranges above 2.0 g/10 minutes are included herein and disclosed herein. For example, the first linear low density polyethylene can have a melt index from a lower limit of 2.0, 3.0, 4.0, 5.0, 6.0, or 10 g/10 minutes. In some embodiments, the polyethylene in the second layer for a cast film application can have an 12 of up to 15 g/10 minutes. In some embodiments, depending on the other components in the second layer or other layers, the polyethylene in the second layer for a cast film application can have an upper limit of 12 of less than 2.0 g/10 minutes. In some embodiments, the polyethylene in the second layer for a cast film application can have a melt index (I₂) of 0.1-2.0 g/10 minutes, or 0.5-2.0 g/10 minutes. All individual values and subranges from 0.1 to 2.0 g/10 minutes are included herein and disclosed herein.

Examples of polyethylenes that can be used in the second layer include those commercially available from The Dow Chemical Company under the names DOWLEX™ and ELITE™, and ATTANE™, such as DOWLEX™ 2045G, DOWLEX™ 2038.68, ELITE™ 5111G, ELITE™ 5400G, ELITE™ 5960G, and ATTANE™ 4203.

In embodiments where the second layer comprises <100% of the polyethylene described above, the second layer further comprises one or more additional polyethylene resins such as, for example, one or more low density polyethylenes having a melt index from 0.1 to 5 g/10 minutes, one or more additional linear low density polyethylenes having a density of 0.930 g/cc or less and a melt index from 0.1 to 5 g/10 minutes.

In embodiments wherein the film is a multilayer film having first and second layers as described above, the film can further comprise one or more inner layers between the first layer and the second layer. In such embodiments, at least one of the inner layers can comprise from 40 to 100 percent by weight of a high density polyethylene (HDPE) and/or medium density polyethylene (MDPE). All individual values and subranges from 40 to 100 percent by weight (wt %) are included herein and disclosed herein; for example the amount of the high density polyethylene can be from a lower limit of 40, 50, 60, 70, 80, or 90 wt % to an upper limit of 50, 60, 70, 80, 90, or 100 wt %. For example, the amount of the high density polyethylene can be from 50 to 100 wt %, or in the alternative, from 60 to 90 wt %, or in the alternative, from 65 to 95 wt %, or in the alternative from 70 to 100 wt %.

When an inner layer includes a medium density polyethylene, the medium density polyethylene has a density of 0.930 g/cc (cm³) to 0.940 g/cc. All individual values and subranges from 0.930 to 0.940 g/cc are included herein and disclosed herein; for example, the density of the polyethylene can be from a lower limit of 0.930, 0.935, or 0.937 g/cc to an upper limit of 0.935, 0.937, or 0.940 g/cc.

When an inner layer includes a high density polyethylene, the high density polyethylene has a density of 0.940 g/cc (cm³) to 0.970 g/cc. All individual values and subranges from 0.940 to 0.970 g/cc are included herein and disclosed herein; for example, the density of the polyethylene can be from a lower limit of 0.940, 0.945, 0.950, or 0.960 g/cc to an upper limit of 0.950, 0.960, or 0.970 g/cc. In some embodiments, the high density polyethylene has a density of 0.940 g/cc or more.

The medium density polyethylene and/or high density polyethylene has a peak melting point of 126° C. to 135° C. in some embodiments, preferably between 126 and 132° C., more preferably between 127 and 132° C.

The melt index of the medium density and/or high density polyethylene in the at least one inner layer can depend on a number of factors including whether the film is a blown film or a cast film. In embodiments where the film is a blown film, the medium and/or high density polyethylene has an I₂ less than or equal to 2.0 g/10 minutes. All individual values and subranges from 2.0 g/10 minutes are included herein and disclosed herein. For example, the medium and/or high density polyethylene can have a density from an upper limit of 2.0, 1.7, 1.4, 1.1, or 0.9 g/10 minutes. In a particular aspect of the invention, the medium and/or high density polyethylene has an 12 with a lower limit of 0.1 g/10 minutes. All individual values and subranges from 0.1 g/10 minutes are included herein and disclosed herein. For example, the medium and/or high density polyethylene can have an I₂ greater than or equal to 0.1, 0.2, 0.3, or 0.4 g/10 minutes.

In other embodiments, the film can be a cast film. In such embodiments, the medium and/or high density polyethylene has an I₂ greater than or equal to 2.0 g/10 minutes. All individual values and subranges above 2.0 g/10 minutes are included herein and disclosed herein. For example, the medium and/or high density polyethylene in the at least one inner layer can have a melt index from a lower limit of 2.0, 3.0, 4.0, 5.0, 6.0, or 10 g/10 minutes. In some embodiments, the medium and/or high density polyethylene in the at least one inner layer for a cast film application can have an 12 of up to 15 g/10 minutes. In some embodiments, depending on the other components in the inner layer(s) or other layers, the medium and/or high density polyethylene in the at least one inner layer for a cast film application can have an upper limit of 12 of less than 2.0 g/10 minutes. In some embodiments, the medium and/or high density polyethylene in the at least one inner layer for a cast film application can have a melt index (I₂) of 0.1-2.0 g/10 minutes, or 0.5-2.0 g/10 minutes. All individual values and subranges from 0.1 to 2.0 g/10 minutes are included herein and disclosed herein.

Examples of medium and high density polyethylenes that can be used in at least one inner layer include enhanced polyethylenes commercially available from The Dow Chemical Company under the names ELITE™, such as, ELITE™ 5940G and ELITE™ 5960G.

In embodiments where an inner layer comprises <100% of the polyethylene described above, the inner layer further comprises one or more additional polyethylene resins such as, for example, one or more low density polyethylenes having a melt index from 0.1 to 5 g/10 minutes, one or more linear low density polyethylenes having a density of 0.930 g/cc or less and a melt index from 0.1 to 5 g/10 minutes.

In addition to an inner layer comprising 40 to 100 percent by weight of a medium and high density polyethylene, in some embodiments, the film can comprise one or more additional inner layers comprising other polyethylenes or combinations of polyethylenes, such as one or more low density polyethylenes, one or more linear low density polyethylenes, or combinations thereof. For example, in one embodiment, the film comprises at least one additional inner layer wherein the additional inner layer comprises 50 to 100 weight percent of a polyethylene having a density of 0.920 g/cc (cm³) or less. All individual values and subranges for a density of polyethylene from 0.920 g/cc are included herein and disclosed herein; for example, the density of the polyethylene can be to an upper limit of 0.900, 0.905, 0.910, 0915, or 0.920 g/cc. Such inner layers can be provided, for example, to enhance the strength of the film.

The melt index of the polyethylene in the at least one additional inner layer can depend on a number of factors including whether the film is a blown film or a cast film. In embodiments where the film is a blown film, the polyethylene in the at least one additional layer has an I₂ less than or equal to 2.0 g/10 minutes. All individual values and subranges from 2.0 g/10 minutes are included herein and disclosed herein. For example, the polyethylene can have a density from an upper limit of 2.0, 1.7, 1.4, 1.1, or 0.9 g/10 minutes. In a particular aspect of the invention, the polyethylene has an I₂ with a lower limit of 0.01 g/10 minutes. All individual values and subranges from 0.1 g/10 minutes are included herein and disclosed herein. For example, the polyethylene can have an I₂ greater than or equal to 0.1, 0.2, 0.3, or 0.4 g/10 minutes.

In other embodiments, the film can be a cast film. In such embodiments, the polyethylene in the at least one additional inner layer has an I₂ greater than or equal to 2.0 g/10 minutes. All individual values and subranges above 2.0 g/10 minutes are included herein and disclosed herein. For example, the polyethylene can have a melt index from a lower limit of 2.0, 3.0, 4.0, 5.0, 6.0, or 10 g/10 minutes. In some embodiments, the polyethylene in the at least one additional inner layer for a cast film application can have an I₂ of up to 15 g/10 minutes. In some embodiments, depending on the other components in the inner layer(s) or other layers, the polyethylene in the at least one additional inner layer for a cast film application can have an upper limit of I₂ of less than 2.0 g/10 minutes. In some embodiments, the polyethylene in the at least one additional inner layer for a cast film application can have a melt index (I₂) of 0.1-2.0 g/10 minutes, or 0.5-2.0 g/10 minutes. All individual values and subranges from 0.1 to 2.0 g/10 minutes are included herein and disclosed herein.

Examples of polyethylenes having a density of 0.920 g/cc or less that can be used in the at least one additional inner layer include those commercially available from The Dow Chemical Company under the names DOWLEX™, ELITE™, and ATTANE™, such as DOWLEX™ 2045G, ELITE™ 5401G, and ATTANE™ 4203G.

In any of the above layers (but preferably in the inner layers) of a multilayer film, other polyolefin resins can be included in addition to the polyethylene for a variety of reasons. For example, a layer in a multilayer film can comprise other polyolefin resins, such as polypropylene and/or cyclic olefin copolymers (e.g., cyclic olefin copolymers commercially available from TOPAS Advanced Polymers such as TOPAS 6013), to provide increased stiffness without significant harm to the compatibility among materials and potential recyclability. In such embodiments, the additional polyolefin resins can be provided in amounts less than 50 weight percent.

In some embodiments, a multilayer film that can be used in coated films of the present invention can comprise 3 or more layers. A multilayer film that can be used in coated films of the present invention can comprise up to 7 layers in some embodiments. The number of layers in the film can depend on a number of factors including, for example, the desired thickness of the multilayer film, the desired properties of the multilayer film, the intended use of the multilayer film, and other factors.

In some embodiments, one or more layers in multilayer film can comprise one or more additives. Additives can include, but are not limited to, antistatic agents, color enhancers, dyes, lubricants, fillers (for example, TiO2 or CaCO3), opacifiers, nucleating agents, partitioning agents, processing aids, pigments, primary anti-oxidants, secondary anti-oxidants, UV stabilizers, anti-blocks, slip agents, tackifiers, fire retardants, anti-microbial agents, odor reducer agents, anti-fungal agents, and combinations thereof, depending on the requirements of a particular application.

In some embodiments, depending on the desired use or requirements of the film, the film can comprise other layers such as barrier layers. For example, for some uses, it may be desirable for the film to provide a barrier to moisture, light, aroma/odor, and/or oxygen transmission. Such barrier layers can include, for example, polyamide films, ethylene vinyl alcohol films, layers formed from or incorporating cyclic olefin copolymers, layers incorporating clays, talc, mica, or similar materials, and other layers as known to those of skill in the art. In such embodiments, one or more tie layers may be included in the film to adhere the barrier layer(s) to the polyethylene-based layer(s).

In some embodiments, the polyurethane coating may have barrier properties.

In some embodiments, a film to be coated with the polyurethane coating comprises a monolayer film. In such embodiments, the monolayer film can comprise from 70 to 100 percent by weight polyethylene having a density less than 0.930 g/cm³ and a melt index (12) of less than 2.0 g/10 minutes, and a peak melting point of less than 126° C. All individual values and subranges from 70 to 100 percent by weight (wt %) are included herein and disclosed herein; for example the amount of the polyethylene can be from a lower limit of 70, 80, or 90 wt % to an upper limit of 80, 90, or 100 wt %. For example, the amount of the polyethylene can be from 80 to 100 wt %, or in the alternative, from 70 to 90 wt %, or in the alternative, from 75 to 95 wt %, or in the alternative from 80 to 100 wt %.

The polyethylene used in the monolayer has a density less than or equal to 0.930 g/cc (cm³). All individual values and subranges less than or equal to 0.930 g/cc are included herein and disclosed herein; for example, the density of the polyethylene can be from an upper limit of 0.928, 0.925, 0.920 or 0.915 g/cc. In some aspects of the invention, the polyethylene has a density greater than or equal to 0.870 g/cc. All individual values and subranges between 0.870 and 0.930 g/cc are included herein and disclosed herein.

The polyethylene used in the monolayer has a peak melting point of 126° C. or less in some embodiments, preferably between 70 and 121° C., more preferably between 80 and 121° C.

The melt index of the polyethylene used in the monolayer (I₂) is less than or equal to 2.0 g/10 minutes in some embodiments. All individual values and subranges from 2.0 g/10 minutes are included herein and disclosed herein. For example, the polyethylene can have a density from an upper limit of 2.0, 1.7, 1.4, 1.1, or 0.9 g/10 minutes. In a particular aspect of the invention, the polyethylene has an 12 with a lower limit of 0.1 g/10 minutes. All individual values and subranges from 0.1 g/10 minutes are included herein and disclosed herein. For example, the polyethylene can have an I₂ greater than or equal to 0.1, 0.2, 0.3, or 0.4 g/10 minutes.

Examples of polyethylenes having a density of 0.930 g/cc or less, a melt index (I₂) of 2.0 g/10 minutes or less, and a peak melting point of 126° C. or less that can be used in a monolayer film according to some embodiments include those commercially available from The Dow Chemical Company under the names AFFINITY™, ELITE™ AT, and ATTANE™, such as AFFINITY™ PL 1146G, AFFINITY™ 1888, ELITE™ AT 6401, ELITE™ 5401G, and ATTANE™ 4203.

In the case of a monolayer film, other polyolefin resins can be included in the monolayer in addition to the polyethylene for a variety of reasons. For example, the monolayer can comprise polyolefin resins, such as polypropylene and/or cyclic olefin copolymers (e.g., cyclic olefin copolymers commercially available from TOPAS Advanced Polymers such as TOPAS 6013), to provide increased stiffness. In such embodiments, the additional polyolefin resins can be provided in amounts less than 50 weight percent.

In embodiments where the monolayer comprises <100% of the polyethylene described above, the monolayer further comprises one or more additional polyethylene resins such as, for example, one or more low density polyethylenes having a melt index from 0.1 to 5 g/10 minutes, one or more additional linear low density polyethylenes having a density of 0.930 g/cc or less and a melt index from 0.1 to 5 g/10 minutes.

It is preferred that the films used in embodiments of the present invention be formed in a blown film or cast film process as is generally known in the art, although other methods such as lamination can be used.

The present invention provides a polyurethane-based coating on an outer surface of the film. In the case of a multilayer film, the outer surface is the outer surface of the second layer comprising from 60 to 100 percent by weight polyethylene having a density of 0.905 to 0.970 g/cm³ and a peak melting point in the range of 100° C. to 135° C. In the case of a monolayer film, the polyurethane-based coating is on one of the outer surfaces of the film.

The term “polyurethane-based coating” is used to indicate that upon curing, the coating comprises primarily polyurethane but that the coating may also include, in some embodiments, unreacted reactants (e.g., polyols, etc.) as well as other additives. In some embodiments, the polyurethane is formed from (a) a polycarbamate having an average of 2.5 or more carbamate functional groups and (b) a polyaldehyde, wherein the polyaldehyde is a dialdehyde, a trialdehyde, or an acetal or hemiacetal thereof, and wherein the polyaldehyde comprises 2 to 20 carbon atoms. As set forth below, other components, such as a triggering agent, can be used in the mixture that forms the polyurethane.

As noted above, the polyurethane-based coatings used in embodiments of the present invention are substantially free of isocyanate groups, meaning that such coating having less than 5 mole percent (mol %) of —N═C═O groups (i.e., isocyanate groups) based on total moles of carbamate groups plus isocyanate groups in the composition, preferably, less than 3 mol %, or, more preferably, less than 1 mol %, and, still more preferably, less than 0.1 mol %. In some embodiments, the crosslinked polyurethane coating cures at room temperature.

In some embodiments, a substantially isocyanate-free multicomponent composition for forming the crosslinked polyurethane comprises a polycarbamate as a first component and a polyaldehyde, or an acetal or hemiacetal thereof, as a second component, wherein the multicomponent composition further comprises an effective amount of a triggering agent such that the first and second components when combined form a composition that reacts to cure at a temperature of from 0° C. to less than 80° C. to form the crosslinked polyurethane, and, further wherein, the composition resulting when all components of the multicomponent composition are combined has a pH of 7.0 or less. The first component and second component, when combined and cured form a crosslinked polyurethane.

Preferably, in the first component, the polycarbamate has an average of 2.5 or more, or, more preferably, 3.0 or more carbamate functional groups, such as up to 100, or, preferably, up to 20 carbamate functional groups.

Preferably, the polycarbamate is, for example, the condensation product of one or more polyols with an unsubstituted carbamic acid alkyl ester or urea. Suitable polyols may include, for example, an acrylic, saturated polyester, alkyd, polyether or polycarbonate polyol. More preferably, the polycarbamate has carbamate groups and hydroxyl groups in a ratio of the equivalents of carbamate groups to the number of equivalents of hydroxyl functional groups of from 1:1 to 20:1 or, preferably, 5.5:4.5 or higher, or, preferably, up to 10:1. Such a ratio can be determined by dividing the average number of carbamate functional groups by the average number of hydroxyl functional groups in the polycarbamate. The term “average number of hydroxyl functional groups in the polycarbamate” is the average number of hydroxyl groups left in the polycarbamate after it is made from a polyol and means the number determined by hydroxyl titration of the polycarbamate to determine its hydroxyl number, followed by calculation of the number of hydroxyl groups reacted to form carbamate groups in making the polycarbamate from a polyol by comparing the hydroxyl number to the initial number of hydroxyl groups in the polyol.

In the second component of the multicomponent composition that forms the crosslinked polyurethane, the polyaldehyde, acetal or hemiacetal thereof preferably has a solubility in water of from 0.015 to 0.20 gram of polyaldehyde per milliliter of water at 25° C., preferably, up to 0.15 gram, or, preferably, 0.03 gram or more. Less preferred are more water soluble polyaldehydes, such as glyoxal or glutaraldehyde.

Preferably, the polyaldehyde is chosen from a C₅ to C₁₁ alicyclic or aromatic dialdehyde, or, more preferably, a C₆ to C₁₀ alicyclic or aromatic dialdehyde, such as, for example, (cis,trans)-1,4-cyclohexanedicarboxyaldehydes, (cis,trans)-1,3-cyclohexanedicarboxyaldehydes and mixtures thereof.

In the multicomponent composition, the triggering agent may be an acid with a pKa of less than 6.0 in some embodiments.

The polycarbamate may have an average of 2.5 or more carbamate groups, or an average of three or more carbamate groups, or an average of four or more carbamate groups. As used herein, the term “average number of carbamate groups” assumes full conversion of the polyol or (poly)isocyanate used to form the polycarbamate and means the total number average molecular weight of the polycarbamate as determined by gel permeation chromatography divided by the number of hydroxyl groups in the polyol used to make the carbamate or the number of isocyanate groups in the (poly)isocyanate used to make the carbamate, whichever is used. In the case of an alkyd, the number of hydroxyl groups equals the number average molecular weight of the alkyd as determined by GPC divided by the hydroxyl equivalent weight of the alkyd, i.e. 56,100 mg KOH/mole KOH divided by the hydroxyl number in mg KOH/g resin. Further, the number average molecular weight of the polycarbamate can be determined by GPC of the polyol or polyisocyanate followed by including in the added weight from reaction with urea or alkyl carbamate to make the polycarbamate.

The polycarbamate can be acyclic, straight or branched; cyclic and nonaromatic; cyclic and aromatic, or a combination thereof. In some embodiments the polycarbamate comprises one or more acyclic, straight or branched polycarbamates. For example, the polycarbamate may consist essentially of one or more acyclic, straight or branched polycarbamates.

Preferably the polycarbamate consists essentially of, and more preferably consists of carbon, hydrogen, nitrogen, and oxygen atoms. Still more preferably the polycarbamate consists of carbon, hydrogen, nitrogen, and oxygen atoms, wherein each nitrogen and oxygen atom is the nitrogen or oxygen atom of one of the two or more carbamate groups of the polycarbamate.

Typically the polycarbamate is prepared by (a) reacting a polyol with O-methyl carbamate or urea to give the polycarbamate; (b) reacting a polyisocyanate with an O-hydroxy(C₂-C₂₀)alkyl-carbamate to give the polycarbamate; or (c) reacting the O-hydroxy(C₂-C₂₀)alkyl-carbamate with methacrylic anhydride to give a 2-carbamoylalkyl methacrylate, and then polymerizing the 2-carbamoylalkyl methacrylate with an acrylic acid monomer to give the polycarbamate as a polyacrylic-based polycarbamate. The polycarbamates produced in (a) to (c) typically will have different structures. Examples of these reactions are illustrated graphically below in respective Schemes (a) to (c):

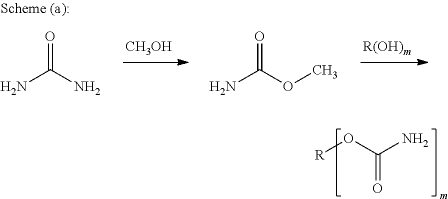

wherein m is as defined for Scheme (a) and R(OH)ₘ, where m is 2 or greater.

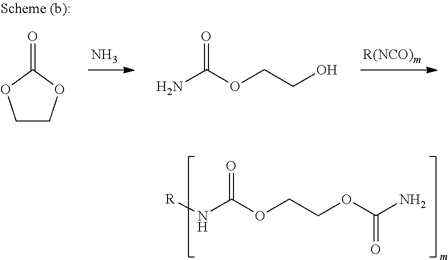

wherein m is an integer of from 2 or greater. Preferably m is an integer of from 2 to 20. In some embodiments m is 2 or 3.

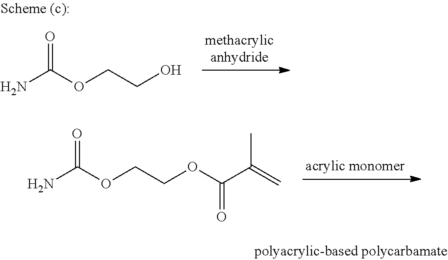

wherein methacrylic anhydride is [CH₂═C(CH₃)C(═O)]₂O and examples of acrylic monomers are acrylic acid, (C₁-C₂₀)alkylacrylic acid (e.g., the (C₁)alkylacrylic acid is methacrylic acid), and (C₁-C₂₀)alkyl acrylate (i.e., acrylic acid (C₁-C₂₀)alkyl ester, e.g., (C₁)alkyl acrylate means methyl acrylate). Not shown in Scheme (c), other olefinic monomers (e.g., styrene) can also be employed along with the acrylic monomer, thereby preparing the polycarbamate as a poly(acrylic other olefinic monomer)-based polycarbamate.

Preferably, each of the one or more acyclic, straight or branched polycarbamates is prepared by reacting one or more polyols with an unsubstituted carbamic acid alkyl ester or urea to yield the one or more acyclic, straight or branched polycarbamates. Suitable polyols may be (meth)acrylic polyols (i.e., a methacrylic or acrylic polyol), polyalkylene polyols, polyether polyols (e.g., a poly(oxyalkylene) such as a poly(oxyethylene), such as a poly(ethylene glycol), polyester polyols, or polycarbonate polyols. Preferably, the polyalkylene polyol is a polyalkylene glycol. Preferably the polyalkylene glycol is a polyethylene glycol or polypropylene glycol.

More preferably, the polycarbamate comprises one or more cyclic, nonaromatic polycarbamates and may consist essentially of one or more cyclic, nonaromatic polycarbamates.

In some embodiments, each of the one or more cyclic, nonaromatic polycarbamates is a N,N′,N″-trisubstituted-cyanuric acid derivative, wherein each substituent thereof independently is of formula: H₂NC(═O)O—(CH₂)ₙ—OC(═O)NH—CH₂—((C₃-C₁₂)cycloalkyl)CH₂—, wherein n is an integer of from 2 to 20. Preferably each n independently is an integer of from 2 to 12 and each cyclohexylene independently is a 1,3-cyclohexylene or 1,4-cyclohexylene. More preferably, n is 2 and the N,N′,N″-trisubstituted-cyanuric acid is the following compound:

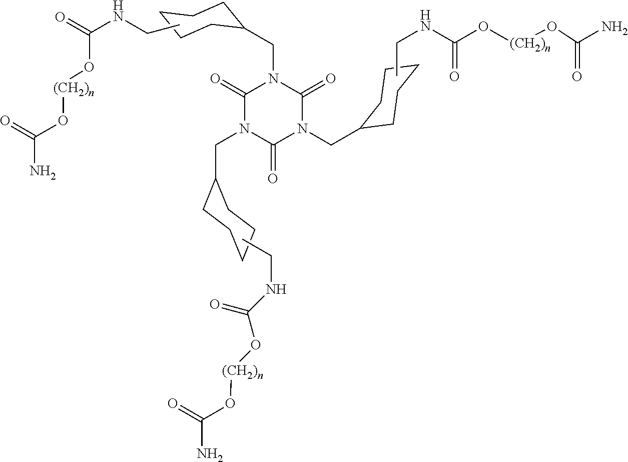

The polycarbamate is substantially isocyanate free. The presence or absence of molecules containing isocyanate groups can be readily determined by Fourier Transform Infrared (FT-IR) spectroscopy or carbon-13 nuclear magnetic resonance (¹³C-NMR) spectroscopy.

Additional information regarding polycarbamates that can be used to form the crosslinked polyurethane coating can be found in U.S. Pat. No. 8,653,174, which is hereby incorporated by reference.

With regard to the polyaldehyde that can be used to form the crosslinked polyurethane coating, the polyaldehyde comprises one or more cyclic, nonaromatic polyaldehydes or one or more aromatic polyaldehydes. For example, the polyaldehyde comprises one or more cyclic, nonaromatic polyaldehydes having from 3 to 20 ring carbon atoms, and may consist essentially of one or more cyclic, nonaromatic polyaldehydes having from 3 to 20 ring carbon atoms.

More preferably, each cyclic, nonaromatic polyaldehyde independently has from 5 to 12 ring carbon atoms, and, even more preferably, is a mixture of (cis,trans)-1,4-cyclohexanedicarboxyaldehydes and (cis,trans)-1,3-cyclohexanedicarboxyaldehydes.

The polyaldehyde may comprise one or more acyclic, straight or branched polyaldehyde having from 2 to 16 carbon atoms.

In another embodiment, each of the one or more acyclic, straight or branched polyaldehydes having 16 carbon atoms or more is prepared by hydroformylating a substantially water insoluble multi-olefin-containing compound that is derived from a fatty acid ester or, more preferably, a seed oil. For example, each of the one or more acyclic, straight or branched polyaldehydes having 16 carbon atoms or more is prepared by hydroformylating a multi-olefin-containing oligomer or polymer. Preferably, the multi-olefin-containing compound that is derived from the seed oil is a multi-olefin-containing fatty acid triglyceride having 48 carbon atoms or more.

Examples of suitable cyclic polyaldehydes are trans-1,3-cyclohexanedicarboxaldehyde; cis-1,3-cyclohexanedicarboxaldehyde; trans-1,4-cyclohexanedicarboxaldehyde; cis-1,4-cyclohexanedicarboxaldehyde; a mixture of 1,3-cyclohexanedicarboxaldehydes and 1,4-cyclohexanedicarboxaldehydes, preferably a 1-to-1 mixture thereof; exo,exo-2,5-norbornanedicarboxaldehyde; exo,exo-2,6-norbomanedicarboxaldehyde; exo,endo-2,5-norbomanedicarboxaldehyde; exo,endo-2,6-norbornanedicarboxaldehyde; endo,endo-2,5-norbomanedicarboxaldehyde; endo,endo-2,6-norbornanedicarboxaldehyde product (endo and exo mixture); 3-(3-formylcyclohexyl)propanal; 3-(4-formylcyclohexyl)propanal; 2-(3-formylcyclohexyl)propanal; 2-(4-formylcyclohexyl)propanal; and cyclododecane-1,4,8-tricarbaldehyde. The trans-1,3-cyclohexanedicarboxaldehyde; cis-1,3-cyclohexanedicarboxaldehyde; trans-1,4-cyclohexanedicarboxaldehyde; and cis-1,4-cyclohexanedicarboxaldehyde can be prepared by a process comprising hydroformylating 3-cyclohexene-1-carboxaldehyde. The 1:1 mixture of 1,3- and 1,4-cyclohexanedicarboxaldehydes can be prepared by a process comprising reacting acrolein and 1,3-butadiene in a Diels-Alder reaction to give 3-cyclohexenecarboxaldehyde (also called 1,2,3,6-tetrahydrobenzaldehyde), and hydroformylating the 3-cyclohexenecarboxaldehyde. The exo,exo-2,5-norbomanedicarboxaldehyde; exo,exo-2,6-norbornanedicarboxaldehyde; exo,endo-2,5-norbomanedicarboxaldehyde; exo,endo-2,6-norbornanedicarboxaldehyde; endo,endo-2,5-norbomanedicarboxaldehyde; and endo,endo-2,6-norbomanedicarboxaldehyde product (endo and exo mixture) can be prepared by a process comprising reacting acrolein and cyclopentadiene in a Diels-Alder reaction to give a 2-norbornene-5-carboxaldehyde, and hydroformylating the 2-norbomene-5-carboxaldehyde. The 3-(3-formylcyclohexyl)propanal; 3-(4-formylcyclohexyl)propanal; 2-(3-formylcyclohexyl)propanal; and 2-(4-formylcyclohexyl)propanal can be prepared by a process comprising hydroformylating vinyl cyclohexene. The cyclododecane-1,4,8-tricarbaldehyde can be prepared by a process comprising trimerizing 1,3-butadiene to give 1,4,8-cyclododecatriene, and hydroformylating the 1,4,8-cyclododecatriene.

The polyaldehyde can be unblocked and unprotected or blocked or protected. Blocked or protected polyaldehydes can be formed by reacting an unblocked and unprotected polyaldehyde with a suitable blocking or protecting group. Examples of protecting or blocking groups for aldehyde groups are bisulfites (e.g., from reaction of the polyaldehyde with sodium bisulfite), dioxolanes (e.g., from reaction of the polyaldehyde with ethylene glycol), oximes (e.g., from reaction of the polyaldehyde with hydroxylamine), imines (e.g., from reaction of the polyaldehyde with methylamine), and oxazolidines (e.g., from reaction of the polyaldehyde with a 2-aminoethanol).

Preferred aldehyde protecting groups are, and preferred protected polyaldehydes comprise, a hydrated group (>C(OH)2), hemiacetal, acetal, or imine. These preferred protected polyaldehydes can be prepared by respectively reacting the polyaldehyde with water; one mole equivalent of an alkanol (e.g., methanol or ethanol); two mole equivalents of the alkanol; or ammonia or a primary amine (e.g., methylamine). The hemiacetal, acetal, or imine protecting group can, if desired, be removed by a deprotection such as hydrolysis to give back the unprotected form of the polyaldehyde. Such aldehyde protecting or blocking groups and formation and removal (i.e., deprotection) is taught, for example, in U.S. Pat. No. 6,177,514 B1.

Preferably, the polyaldehyde is stable in neat form (i.e., does not materially self-polymerize) and, more preferably, is substantially water insoluble and is stable in neat form.

Additional information regarding polyaldehydes that can be used to form the crosslinked polyurethane coating can be found in U.S. Pat. No. 8,653,174, which is hereby incorporated by reference.

The polycarbamates and polyaldehydes make up a multicomponent composition that can be cured to form a crosslinked polyurethane. In some embodiments, the multicomponent composition may consist essentially of the polyaldehyde and the polycarbamate, or separately, a triggering agent. In some embodiments, such compositions may be curable at ambient temperature and consist essentially of polycarbamate, polyaldehyde, and a triggering agent. Such multicomponent compositions and ambient temperature curable compositions are substantially formaldehyde free and substantially isocyanate free in some embodiments.

The curing step preferably is initiated by a triggering event, triggering agent, or a combination thereof. Such initiation is performed by beginning exposure of the multicomponent composition to the triggering event, triggering agent, or combination thereof; and continuing such exposure for a period of time sufficient to produce the crosslinked polyurethane coating. An example of the triggering event is heat. Preferably heat is applied radiantly although other means such as by convection or combinations of means can be used. Preferably, the triggering agent is used in an amount of from 0.001 wt % to 10 wt % of the multicomponent composition, based on the total weight of solids in the composition, more preferably from 0.01 wt % to 5 wt % thereof, or, preferably from 0.1 wt % to 2 wt % thereof. Such amounts of the triggering agent are referred to herein as “effective amounts” of the triggering agent.

Any compound, substance or material suitable for increasing a rate of reaction of a carbamate group (—O—C(═O)—NH₂) with an aldehyde group (—C(═O)H) can be employed as the triggering agent. Examples of triggering agents are Lewis acids (e.g., boron trifluoride etherate) and protic acids (i.e., Brçnsted acids). Preferably, the triggering agent comprises a protic acid characterizable as having a pKₐ of 6 or lower, wherein pKₐ is negative base-10 logarithm of acid dissociation constant, Kₐ, of the protic acid. Thus, the ambient temperature curable composition has a pH of 7.0, or less, preferably, from pH 3 to pH<6. A preferred protic acid is an inorganic protic acid or organic protic acid. A preferred inorganic protic acid is phosphoric acid or sulfuric acid. A preferred organic protic acid is carboxylic acid, phosphonic acid, or sulfonic acid. A preferred carboxylic acid is acetic acid, trifluoroacetic acid, propionic acid, or a dicarboxylic acid. A preferred phosphonic acid is methylphosphonic acid. A preferred sulfonic acid is methanesulfonic acid, benzenesulfonic acid, a camphorsulfonic acid; para-toluenesulfonic acid, or dodecylbenzenesulfonic acid. Examples of suitable Lewis acid curing catalysts are AlCl₃; benzyltriethylammonium chloride (TEBAC); Cu(O₃SCF₃)₂; (CH₃)₂BrS⁺Br⁻; FeCl₃ (e.g., FeCl₃.6H₂O); HBF₄; BF₃.O(CH₂CH₃)₂; TiCl₄; SnCl₄; CrCl₂; NiCl₂; and Pd(OC(O)CH₃)₂.

The triggering agent can be unsupported (no solid support) or supported, i.e. covalently bonded to a solid support. Examples of supported triggering agents are supported curing catalysts such as supported acid catalysts such as acid (H⁺) forms of cation exchange-type polymer resins (e.g., ethanesulfonic acid, 241-[difluoro[(1,2,2-trifluoroethenyl)oxy]methyl]-1,2,2,2-tetrafluoroe thoxy]-1,1,2,2-tetrafluoro-, polymer with 1,1,2,2-tetrafluoroethene sold under trade name NAFION NR 50 (E. I. du Pont de Nemours & Co., Inc., Wilmington, Del.) and ethenylbenzenesulfonic acid polymer with diethenylbenzene sold as AMBERLYS™ 15 (The Dow Chemical Company, Midland, Mich., USA.).

To form the ambient temperature curable composition, a polyaldehyde, an effective amount of a triggering agent and a polycarbamate are mixed together.

The crosslinked polyurethane comprises a plurality of the connecting carbamate diradicals. The term “connecting carbamate diradical” refers to a molecule formed by reaction of an aldehyde group of, or from the polyaldehyde and a carbamate group of, or from the polycarbamate. The connecting carbamate diradical comprises a hemi-aminal group or a geminal bis(urethane) group. The hemi-aminal group comprises a diradical structure of formula (I):

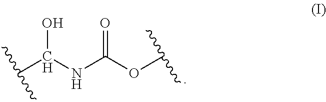 [SMILES: *OC(=O)NC(*)O]

The hemi-aminal group is formed from a reaction of one carbamate group of the polycarbamate with one aldehyde group of the polyaldehyde. The geminal bis(urethane) group comprises a moiety of the formula (II):

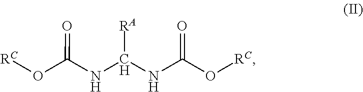

wherein R^{A} is a residual of the polyaldehyde (e.g., dialdehyde) and R^{C} is a residual of the polycarbamate (e.g., dicarbamate). The geminal bis(urethane) group is formed from a reaction of two carbamate groups with one aldehyde group of the polyaldehyde. Formation of the geminal bis(urethane) group from the reaction of the polyaldehyde and polycarbamate occurs at acidic pH, i.e., where pH of the ambient temperature curable composition is pH≤7.0, e.g., from pH 3 to pH<6; and that such formation of the geminal bis(urethane) group cannot occur at basic pH, i.e., where pH of the invention ambient temperature curable composition is pH >7.0, e.g., from pH 7.1 to pH 14). Typically one of the two carbamate groups is from one polycarbamate molecule and the other of the two carbamate groups is from another polycarbamate molecule (i.e., each R^{C} in formula (G-BU) is from a different polycarbamate molecule). The type of connecting carbamate diradicals in the crosslinked polyurethane can be readily identified by analytical techniques such as, for example, one or more of the following techniques: elemental analysis, infrared (IR) spectroscopy (e.g., Fourier Transform IR spectroscopy or FT-IR spectroscopy), mass spectrometry, and nuclear magnetic resonance (NMR) spectroscopy (e.g., proton-NMR spectroscopy such as by observing and integrating the proton on each of the carbon atoms bearing the —OH in formula (H-A) and the proton on each of the carbon atoms bearing R^{A} in formula (G-BU)).

Preferably, the crosslinked polyurethane comprises at least one geminal bis(urethane) group. More preferably, the crosslinked polyurethane comprises a plurality of geminal bis(urethane) groups.

Remarkably, the crosslinked polyurethane can be prepared even when the polyaldehyde has only two aldehyde groups and the polycarbamate has only two or more carbamate groups. This is because at least one aldehyde group of the polyaldehyde is capable of reacting with two carbamate groups, one from each of two different adjacent polycarbamates, thereby crosslinking the adjacent polycarbamates via the polyaldehyde so as to form one of the aforementioned plurality of geminal bis(urethane) groups. Such a double reaction produces a molecule of water as a byproduct.

The geminal bis(urethane) group allows even the dialdehyde to react and crosslink the polycarbamate and thereby form the invention crosslinked polyurethane having dialdehyde-derived crosslinks. The geminal bis(urethane) group can also be formed with the polyaldehyde having three or more aldehyde groups, which polyaldehyde having three or more aldehyde groups thereby crosslinks the polycarbamate so as to form the crosslinked polyurethane having such polyaldehyde-derived crosslinks.

The multicomponent compositions used to form crosslinked polyurethane coatings independently may further comprise one or more additional ingredients. Examples of the additional ingredients include an organic solvent, in the amount of 0.1 weight percent (wt. %) to ≤90 wt. %, based on the total weight of solids in the composition; a dehydrating agent, such as, for example, carboxylic anhydrides, carboxylic acid halides (e.g., acetyl chloride), and sulfonic acid halides (e.g., toluenesulfonyl chloride) in the amount of 0.01 wt % to ≤10 wt. %, based on the total weight of solids in the composition; as well as any of a surfactant, a dispersing agent, a wetting agent, an adhesion promoter, an ultraviolet (UV) light absorber, a light stabilizer, one or more colorants or dyes, and an antioxidant.

Examples of suitable organic solvents are non-polar or polar organic solvents such as, for example, an alkane (e.g., a (C₆-C₁₂)alkane), ether (e.g., (C₂-C₁₂)ether, e.g., a (C₂-C₁₂)dialkyl ether), carboxylic ester (e.g., a (C₂-C₁₂)carboxylic ester), ketone (e.g., a (C₃-C₁₂)ketone), secondary or tertiary carboxamide (e.g., a secondary or tertiary (C₃-C₁₂)carboxamide), sulfoxide (e.g., a (C₂-C₁₂)sulfoxide), or a mixture of two or more thereof.

Preferably, to reduce or eliminate the correlation between pot life of a composition and coating drying time or coating hardness, or both upon curing thereof, the multicomponent compositions of the present invention comprise a curing inhibitor such as, for example, water or a primary alkanol (e.g., (C₁-C₁₂)alkanols). The curing inhibitor may be used to delay onset of or increasing length of time of curing or both of the compositions until such time that curing is desirable, and can be removed from the composition (e.g., by evaporation), thereby initiating or increasing rate of curing thereof. Suitable curing inhibitors have a boiling point at atmospheric pressure of at most 300° C., more preferably at most 250° C., and, still more preferably at most 200° C. Preferably, when the curing inhibitor is present in the multicomponent compositions, it is present in an amount of from 0.5 wt. % to 90 wt. % based on the total weight of solids in the composition, or, more preferably, at most 60 wt. %, and, still more preferably, at most 50 wt. %. Preferably, the curing inhibitor concentration is at least 1 wt. %, based on the total weight of solids in the composition, and, still more preferably, at least 2 wt. %. The curing inhibitor can enable the composition to maintain, if desired, a long pot life (e.g., 14 days or longer), and then, when curing is desired, can be removed (e.g., by evaporation) so as to enable the curing and drying to touch of the resulting composition in a comparable amount of time as curing and drying to touch time of a same composition except lacking the curing inhibitor and enabling the resulting cured and dried coating thereof to exhibit a comparable degree of hardness as a cured and dried coating prepared from the same composition except lacking the curing inhibitor. Curing inhibitors may include, for example, alkanols, water, or mixtures thereof, or, more preferably, primary alkanols. Preferably, the alkanol is present at a concentration of from 0.5 wt % to 50 wt %, based on the total weight of solids in the composition, or more preferably, at most 20 wt %, and, still more preferably, at most 10 wt %. More preferably, the alkanol concentration is at least 1 wt %, based on the total weight of solids in the composition, and still more preferably at least 2 wt %.

In some embodiments, the coating can comprise other components such as oils and/or waxes. Examples of waxes that can be used in coatings in some embodiments of the present invention include, but are not limited to, paraffin wax, microcrystalline wax, carnuba wax, polyfluoro wax, polyfluorochlor wax, and combinations thereof. Examples of oils that can be used coatings in some embodiments of the present invention include, but are not limited to, corn oil, silicon oil, olive oil, canola oil, sunflower, oil, and combinations thereof. While not wishing to be bound by theory, the inclusion of minor amounts of oil and/or wax is believed to modify the smoothness and gloss of films coated with such coatings, to reduce or minimize tackiness of a coated film, and/or to provide a desired kinetic coefficient of friction for the intended use of the coated film. If desired, waxes and/or oils may be added to the solution from suitable solvent media and mixed into the coating to provide a homogeneous coating. The amount of waxes and/or oils to use will depend on the inherent tackiness of the coating (if any), the desired smoothness or gloss value, the type of wax and/or oil to be used, and/or the desired kinetic coefficient of friction for the final coated film.

The coating can be applied to the outer surface of the film using a variety of techniques by which coatings are typically applied to films including, for example, gravure coating, reverse gravure coating, offset gravure coating, smooth roll coating, curtain coating, spray coating, coating with a Mayer rod, multi-roll coating, and flexographic coating, either as an overall coating (100% coverage) and as a pattern applied coating (<100% coverage). Persons of skill in the art with equipment to apply solvent-based and/or water-based coatings and adhesives can readily adapt their process to apply a polyurethane coating to a film to obtain the coated films of the present invention.

The amount of coating applied to the film, in some embodiments, can be at least 1 gram per square meter. As used herein, the amount of coating is determined by measuring the difference of the weight of the film before coating and after the coating is applied and dried. In some embodiments, the amount of coating applied to the film is up to 7 grams per square meter. The amount of coating applied to the film, in some embodiments, is 1 to 7 grams per square meter. All individual values and subranges from 1 to 7 grams per square meter are included herein and disclosed herein; for example, the amount of coating may be from a lower limit of 1, 2, 3, 4, 5, or 6 grams per square meter to an upper limit of 2, 3, 4, 5, 6, or 7 grams per square meter. For example, the amount of coating can be from 3 to 5 grams per square meter in some embodiments.

Various embodiments of coated films of the present invention can have one or more desirable properties including, for example, a broad thermal resistance range, high gloss, stable coefficient of friction on the coated surface, and/or other properties. In some embodiments, coated films of the present invention have a broad thermal resistance range. Coated films, according to some embodiments of the present invention, are thermally resistant when subjected to a W-fold test at a temperature of at least 230° F. As used herein, the thermal resistance of a film using a “W-fold test” is determined as follows. All references herein to “a W-fold test” or “the W-fold test” refer to this procedure. The W-fold test folds a coated film in a “W” shape such that there are uncoated surface-to-uncoated surface and coated surface-to-coated surface interfaces. The folded film is placed into a Sencorp Sealing Machine set at 40 psi with a 2 second dwell time. The temperature is varied from low to high in order to assess the temperatures at which the uncoated surface-to-uncoated surface interface seals, but the coated surface-to-coated surface interface does not seal. A large temperature window between the temperature at which the uncoated surfaces seal and a higher temperature at which the seal between the coated surfaces fails is desired. The starting temperature is set at 230° F., held there for 2 seconds, and then increased in 10° F. until the coated surface-to-coated surface interface starts to mar. The thermal resistance according to the W-fold test is the highest temperature at which the coated surface-to-coated surface interface does not mar.

In some embodiments, a coated film of the present invention is thermally resistant when subjected to the W-fold test at a temperature of at least 230° F. A coated film of the present invention is thermally resistant when subjected to the W-fold test at a temperature of at least 240° F. in some embodiments. A coated film of the present invention, in some embodiments, is thermally resistant when subjected to the W-fold test at a temperature of at least 250° F. A coated film of the present invention, in some embodiments, is thermally resistant when subjected to the W-fold test at a temperature of at least 260° F. A coated film of the present invention is thermally resistant when subjected to the W-fold test at a temperature of at least 270° F. in some embodiments, at least 280° F. in some embodiments, at least 290° F. in some embodiments, at least 300° F. in some embodiments, at least 310° F. in some embodiments, at least 320° F. in some embodiments, at least 330° F. in some embodiments, at least 340° F. in some embodiments, at least 350° F. in some embodiments, at least 360° F. in some embodiments, at least 370° F. in some embodiments, at least 380° F. in some embodiments, at least 390° F. in some embodiments. In some embodiments, a coated film of the present invention is thermally resistant when subjected to the W-fold test to a temperature up to 400° F.

In some embodiments, coated films of the present invention exhibit high gloss, particularly as compared to uncoated polyethylene films. In some embodiments, coated films exhibit a gloss of at least 70 units at 60° when measured according to ASTM D2457. Coated films, in some embodiments, exhibit a gloss of up to 140 units at 60° when measured according to ASTM D2457. In some embodiments, coated films exhibit a gloss of 70 to 140 units at 60° when measured according to ASTM D2457. All individual values and subranges from 70 to 140 units at 60° are included herein and disclosed herein; for example, the gloss can be from a lower limit of 70, 75, 80, 85, or units to an upper limit of 90, 95, or 100 units. For example, in some embodiments, the coated films can exhibit a gloss of at least 85 units at 60° when measured according to ASTM D2457. In some embodiments, coated films exhibit a gloss of 85 to 100 units at 60° when measured according to ASTM D2457.

In some embodiments, coated films of the present invention can exhibit a stable coefficient of friction on the coated surface. For example, in some embodiments, the coated surface exhibits a kinetic coefficient of friction of 0.10 to 1.5 when measured film-to-metal according to ASTM 1894. The coated surface exhibits a kinetic coefficient of friction of 0.10 to 0.40 when measured film-to-metal according to ASTM 1894 in some embodiments.

Embodiments of the present invention also relate to articles formed from any of the coated films disclosed herein. In some embodiments, the article is a flexible package. In some embodiments, the flexible package comprises a first coated film according to the present invention and a second coated film according to the present invention. Alternatively, the flexible package can be formed from a single coated film of the present invention that is folded.

In some embodiments, the flexible package is in the form of one or more of the following: a pillow pouch, a sachet, and a stand up pouch that is formed using techniques known to those of skill in the art based on the disclosure herein.

The thickness of the coated film used to form the flexible package can be selected depending on a number of factors including, for example, the size of the flexible package, the volume of the flexible package, the contents of the flexible package, the desired properties of the flexible package, and other factors. In some such embodiments, the coated film has a thickness used in a flexible package of the present invention has a thickness of 20 to 200 microns. All individual values and subranges from 20 to 200 microns are included herein and disclosed herein; for example, the thickness of the coated film may be from a lower limit of 20, 30, 40, 50, 60, 70, 80, 90, 100, 110, 120, 130, 140, 150, 160, 170, 180, or 190 microns to an upper limit of 30, 40, 50, 60, 70, 80, 90, 100, 110, 120, 130, 140, 150, 160, 170, 180, 190, or 200 microns.

Non-limiting examples of contents suitable for containment by flexible packages of the present invention include comestibles (beverages, soups, cheeses, cereals), liquids, shampoos, oils, waxes, emollients, lotions, moisturizers, medicaments, pastes, surfactants, gels, adhesives, suspensions, solutions, enzymes, soaps, cosmetics, liniments, flowable particulates, and combinations thereof.

Some embodiments of the invention will now be described in detail in the following Examples.

### EXAMPLES

### Preparation of Reactant Compositions for Polyurethane Coating

The following Examples include a multilayer film coated with a polyurethane coating according to an embodiment of the present invention. The polyurethane coating used in these Examples is prepared from two reactant compositions as follows.

### Preparation of Solution for Coating

29.0 grams of an acrylic polycarbamate (PARALOID™ EDGE 2121 resin commercially available from The Dow Chemical Company) is placed into a speed-mixer cup. 30.8 grams of n-butyl acetate is added and mixed for 1 minute at 1500 rpm. 2.0 grams of ethanol and 0.34 grams of a catalyst (K-CURE 1040 from King Industries, Inc.) is added to the speed-mixer cup and mixed for 1 minute at 1500 rpm. 2.5 grams of a crosslinking agent, cyclohexanyl-dicarboxaldehyde, is added and mixed a last time at 1500 rpm for 1 minute. The crosslinking of the acrylic polycarbamate with the dialdehyde results in a polyurethane with a urethane crosslink in the form of an aminal. The resulting solution includes 35 weight percent solids in butyl acetate. To reduce viscosity, the solution is further diluted to 20-25 weight percent solids.

### Preparation of Coated Film

The polyurethane coating is applied to a polyethylene film as follows. The polyethylene film is a seven layer blown having an A/B/B/B/B/B1/C construction as follows in Table 1:

TABLE 1

| | | | | Peak |
|---|---|---|---|---|
| | Component(s) | Nominal | I₂ | Melting |
| | (Nominal | Density | (g/10 | Temp. |
| Layer | Thickness) | (g/cm³) | mins) | (° C.) |
| Top Layer | DOWLEX ™ 5075G (82%) | 0.919 | 1.3 | 112 |
| (A) | AGILITY ™ 1021 (15%) | 0.921 | 1.9 | 108 |
| | Slip Agent (1%) | | | |
| | Anti-Block (2%) | | | |
| | (0.68 mils) | | | |
| Intermediate | ELITE ™ 5960 | 0.962 | 0.85 | 134 |
| Layers (B) | (2.51 mils) | | | |
| Intermediate | ELITE ™ 5400 (85%) | 0.961 | 1.0 | 118 |
| Layer (B1) | AGILITY ™ 1021 (14%) | 0.921 | 1.9 | 108 |
| | Slip Agent (1%) | | | |
| | (0.63 mils) | | | |
| Bottom | AFFINITY ™ | 0.899 | 1.0 | 95 |
| Layer | PF 1146G (95%) | | | |
| (sealing) | Slip Agent (1%) | | | |
| (C) | Anti-Block (4%) | | | |
| | (0.68 mils) | | | |

The percentages in Table 1 are weight percentages based on the total weight of the respective layer. Each of the polyethylene resins are commercially available from The Dow Chemical Company. The outer layer (A) is corona treated. 4-5 inch wide strips of the polyethylene film are cut from the roll to be coated.

The polyurethane coating solution described above is mixed immediately before application. The bubbles are allowed to dissipate for 1 to 3 minutes. The film is attached to a glass plate at the top only using double-sided tape with the corona-treated side of the film facing upward. A paper towel is placed under the glass plate to catch excess coating. A Mayer rod is placed at the top of the film. The target coat weight of solids for these samples is 3 g/m² (gsm). Based on the percent solids, a Mayer rod is selected and the resultant coat weight is measured using the technique describe below. If the coat weight is too low, a higher number Mayer rod is selected and so forth. Most of the samples in this Example are prepared using a #4 Mayer bar for 31 weight percent solids coating solutions and a #6 Mayer bar for 29 weight percent solids coating solutions.

1 to 1.5 milliliters of the coating solution is added to the top of the film below the Mayer rod. The Mayer rod is pulled down quickly to coat the corona treated side of the film. The coating is performed in a hood immediately adjacent to a drying oven. The wet coating is placed into a 70-75° C. vacuum oven for 3 minutes using a dry-ice cooled trap to capture the solvent. A slight vacuum of ˜−5 inches Hg is pulled while leaving the needle valve open as full vacuum is not desirable. After 3 minutes, the film is removed placed on a wire rack to cool. Once cool, the film is transferred to a metal plate, and the edges secured with magnets to prevent excessive curl. The films are allowed to cure for 7 days under ambient conditions before further testing.

### Coat Weight

The amount of coating on the film is measured as follows. A sheet of aluminum foil is attached to a glass plate with double sided tape and smoothed down as much as possible. A Mayer rod is placed at the top of the foil. 1 to 1.5 milliliters of the polyurethane coating solution is applied to the top portion of the aluminum foil below the Mayer rod. The Mayer rod is used to draw down the coating solution, and the plate/foil were placed into a 70-75° C. vacuum oven at ˜−5 in Hg for one minute. The timing is important because at 1 minute most of the solvent is removed when non-absorbent aluminum foil is the substrate, but at longer times the coating is too cross-linked to be easily removed. A 9.70 cm×9.70 cm square template is placed over the coated aluminum foil, and then a curved teasing needle is used to indent the aluminum foil around the template. Metal handled scissors are used to cut along the indented lines to free a piece of coated aluminum foil in the shape of the template. The coated foil is weighed on a four place analytical balance to obtain a first measurement (W1). Ethyl acetate or methyl ethyl ketone are used to wash the coating off of the foil. The washed aluminum foil is dried to remove residual solvent. The aluminum foil is then weighed again to obtain a second measurement (W2). A coat weight is calculated using the following formula:

$$coat weight = \frac{K \times ( W 1 - W 2 )}{A}$$

where K=1×10⁶ mm²/m² and A is the area of the substrate in mm². With the 9.70 cm×9.70 cm square template, the area (A) is 9409 mm².

### Example 1

A coated film of the present invention is evaluated for heat resistance testing. A coated film is prepared as described above with a coat weight of ˜3 g/m². The heat resistance of the coated film is compared to an uncoated polyethylene film having the same construction as above without the coating.

First, the films are screened for potential heat resistance as follows. A TISH-200 impulse sealer (model E82163(s)) is used for the heat resistance screening with the dial set to “9”, the maximum value. Under this condition, an uncoated polyethylene film would melt right through, resulting in two pieces of film on either side of the heating bar. A coated film of the present invention (as described above) that has cured for a minimum of 7 days is cut into 1-inch strips perpendicular to the draw-down direction. Typically, the strips are taken from the middle section of the film, away from the very top or bottom. The film strip is looped over onto itself so that the coated surface is on the outside of the loop and the uncoated surface is on the inside of the loop. The loop is placed into the heat zone of the sealer, and the lever is firmly pressed down. The heat automatically stops after 3 seconds. The lever is released and the loop is removed from the heat zone. Scores are assigned according to the quality of the heat seal. A score of “0” is assigned if the strip melts completely through and the loop is cut off. A score of “5” is assigned if the loop sealed and stuck together, but the seal line is very soft when removed. A score of “10” is assigned if the loop is sealed and stays together and the seal appears strong. In this evaluation, only scores of 0 and 5 are obtained which essentially reduced the testing to “pass” or “fail”. Each film is tested four times and the overall score was an average of the four trials. The uncoated films failed this heat resistance screening test, while the coated films of the present invention passed by forming seals.

Samples that passed the initial heat resistance screening are further evaluated for heat resistance using the W-fold test. The coated film of the present invention (Inventive Film 1) started to mar at a temperature of 270° F. As uncoated polyethylene mars or even starts to seal at 230° F., the coated film shows an improvement in heat resistance.

### Example 2

The gloss values of coated films according to embodiments of the present invention (Inventive Films 1-3) are compared to the gloss values of an uncoated film (Comparative Film A) and a comparative coated film (Comparative Film B). The coated film according an embodiment of the present invention (Inventive Film 1) is prepared using the coating as described above.

### Preparation of Coating for Inventive Film 2

5.8 grams of the acrylic polycarbamate (described above) is placed into a glass vial. 16.59 grams of ethyl acetate is added to the vial and is shaken by hand until thoroughly mixed. 0.04 grams of wax (Synaceti 125 commercially available from Werner G. Smith, Inc.) and 0.04 grams of corn oil are added to the vial. The vial is placed in a 73° C. oven for 1 minute, is removed from the oven, and then shaken by hand to visually evaluate solubility. This process is repeated until the wax and oil are fully dissolved. 0.4 grams of ethanol and 0.068 grams of a catalyst (K-CURE 1040 from King Industries, Inc.) are added to the vial and is shaken by hand until thoroughly mixed. 0.5 grams of a crosslinking agent, cyclohexanyl-dicarboxaldehyde, is added to the vial and the vial is shaken a final time by hand until mixed thoroughly.

### Preparation of Coating for Inventive Film 3

5.8 grams of the acrylic polycarbamate (described above) is placed into a glass vial. 16.59 grams of a 50/50 by weight mixture of ethyl acetate and cyclohexane is added to the vial and is shaken by hand until thoroughly mixed. 0.04 grams of wax (Synaceti 125 commercially available from Werner G. Smith, Inc.) and 0.04 grams corn oil are added to the vial. The vial is placed in a 73° C. oven for 1 minute, is removed from the oven, and then shaken by hand to visually evaluate solubility. This process is repeated until the wax and oil are fully dissolved. 0.4 grams of ethanol and 0.068 grams of a catalyst (K-CURE 1040 from King Industries, Inc.) are added to the vial and is shaken by hand until thoroughly mixed. 0.5 grams of a crosslinking agent, cyclohexanyl-dicarboxaldehyde, is added to the vial and the vial is shaken a final time by hand until mixed thoroughly.

A coated film according one embodiment of the present invention (Inventive Film 2) is prepared as described above, except that the Coating for Inventive Film 2 is applied to the film. A coated film according to another embodiment of the present invention (Inventive Film 3) is prepared as described above, except that the Coating for Inventive Film 3 is applied to the film.

Comparative Film A is the base film as described above. Comparative Film B includes the same base film with a polyurethane coating that includes isocyanates. The coating in Comparative Film B is applied at 31% solids, coated at 3 grams/m², and allowed to cure for at least 7 days at ambient temperature.

The gloss test performed is ASTM D2457 using a BYK Gardner Micro-Tri-Gloss Gloss Meter. The Meter is set to record both 20° and 60° gloss for each sample, measured from top to bottom in 8 different locations while avoiding the very top and very bottom of the film. The gloss varies due to imperfections in both the coating and in the underlying polyethylene film. Therefore, average and standard deviation are measured for each film sample at 20° and 60°. Two samples of each film are measured (except for Inventive Film 2), and the results are shown in Table 2:

TABLE 2

| | Sample | Avg. | Std. Dev. | Avg. | Std. Dev. |
|---|---|---|---|---|---|
| | No. | 20° Gloss | 20° Gloss | 60° Gloss | 60° Gloss |
| Comparative | 1 | 66.8 | 16.0 | 101.1 | 3.0 |
| Film A | 2 | 71.4 | 5.5 | 100.6 | 1.2 |
| Comparative | 1 | 67.5 | 27.5 | 97.8 | 15.1 |
| Film B | 2 | 100.0 | 7.3 | 116.1 | 1.5 |
| Inventive | 1 | 84.9 | 13.4 | 108.8 | 1.2 |
| Film 1 | 2 | 92.4 | 9.6 | 109.3 | 1.3 |
| Inventive | 1 | 89.9 | 25.8 | 108.5 | 17.0 |
| Film 2 | | | | | |
| Inventive | 1 | 82.8 | 24.0 | 117.1 | 32.5 |
| Film 3 | 2 | 79.7 | 24.4 | 108.2 | 17.0 |

The 60° gloss of the Inventive Films is comparable to Comparative Film B (polyurethane coating with isocyanates), and improved over Comparative Film A (uncoated). The 20° gloss also compares favorably.

1. A coated film comprising:
(a) a film comprising:
(i) a first layer comprising from 70 to 100 percent by weight of a polyethylene having a density of 0.930 g/cm³ or less and a peak melting point of less than 126° C.;
(ii) a second layer comprising from 60 to 100 percent by weight polyethylene having a density of 0.905 to 0.970 g/cm³ and a peak melting point in the range of 100° C. to 135° C.; and
(iii) at least one inner layer between the first layer and the second layer comprising from 40 to 100 percent by weight of a polyethylene having a density from 0.930 to 0.970 g/cm³ and a peak melting point in the range of 120° C. to 135° C., wherein the polyethylene is a medium density polyethylene or a high density polyethylene; and
(b) a coating on an outer surface of the second layer of the film comprising a crosslinked polyurethane, wherein the coating is substantially free of isocyanate groups.

2. The coated film of claim 1, wherein the coated film is thermally resistant when subjected to a W-fold test at a temperature of at least 230° F.

3. The coated film of claim 1, wherein the coated film has a gloss of at least 70 units at 60°.

4. The coated film according to claim 1, wherein the film is a blown film.

5. The coated film according to claim 1, wherein the amount of coating on the outer surface of the first layer of the film is 1 to 7 g/m².

6. The coated film according to claim 1, wherein the coated film has a kinetic coefficient of friction of 0.10 to 1.5 on the coated surface.

7. The coated film according to claim 1, wherein the polyurethane is formed from: (a) a polycarbamate having an average of 2.5 or more carbamate functional groups; and (b) a polyaldehyde, wherein the polyaldehyde is a dialdehyde, a trialdehyde, or an acetal or hemiacetal thereof, and wherein the polyaldehyde comprises 2 to 20 carbon atoms.

8. The coated film according to claim 1, wherein the coating further comprises at least one of oil and wax.

9. The coated film according to claim 1, wherein the film comprises one or more lower density inner layers between the first layer and the second layer comprising from 50 to 100 percent by weight polyethylene having a density of 0.92 g/cm³ or less and a peak melting point in the range of 120° C. to 135° C.

10. The coated film according to claim 1, wherein one or more of the layers further comprise polypropylene, a cyclic olefin copolymer, or mixtures thereof in an amount of 50% by weight or less, preferably less than 30% by weight.

11. The coated film according to claim 1, further comprising a barrier layer.

12. A coated film comprising:
(a) a monolayer film comprising from 70 to 100 percent by weight polyethylene having a density less than 0.930 g/cm³ and a melt index (I₂) of less than 2.0 g/10 minutes, and a peak melting point of less than 126° C.; and
(b) a coating on an outer surface of the film comprising a crosslinked polyurethane, wherein the coating is substantially free of isocyanate groups.

13. The coated film of claim 12, wherein the coated film is thermally resistant when subjected to a W-fold test at a temperature of at least 230° F.

14. An article comprising the coated film according to claim 1.

15. The article according to claim 14, wherein the coated film has a thickness of 20 to 200 microns.
